(19) United States
(12) Patent Application Publication
(10) Pub. No.: US 2009/0089222 A1
(43) Pub. Date: Apr. 2, 2009

(54) SYSTEM AND METHOD FOR AUTOMATED STOCK MARKET OPERATION

(76) Inventors: Rodrigo C. Ferreira De Castro, Campinas (BR); Lucas G. Franco, Campinas (BR); Aline G. Pinto, Campinas (BR); Carlos E. Seo, Campinas (BR)

Correspondence Address: HOFFMAN WARNICK LLC, 75 STATE ST, 14 FL, ALBANY, NY, 12207, US

(21) Appl. No.: 12/235,830

(22) Filed: Sep. 23, 2008

(30) Foreign Application Priority Data
Sep. 28, 2007 (CA) 2605662

(51) Int. Cl. G06Q 40/00

(52) U.S. Cl. 705/36 R

(57) ABSTRACT

A system and method for automated stock market investment. In an embodiment, the method includes: i) inputting M previous time period values for the stock into a M-order finite impulse response (FIR) filter, the M-order finite impulse filter having a filter order M, a least mean square (LMS) prediction algorithm with step-size mu, and M adjustable filter coefficients; ii) obtaining an output from the M-order FIR filter, the output from the M-order FIR filter being a predicted next time period value for the stock; iii) comparing the predicted next time period value for the stock with an actual next time period value for the stock to calculate a prediction error; iv) inputting the calculated prediction error into an adaptive algorithm to obtain an adjustment for the at least one adjustable filter coefficient; and v) applying the adjustment for the at least one adjustable filter coefficient and repeating all steps until halted.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

When it comes to personal investments, individuals often seek the services of a bank to invest their money on their behalf. The money may be invested by the bank in mutual funds, or used to purchase various types of bonds or securities, for example. Although this kind of investment is usually safe, it may not provide large gains in the long run. On the other hand, while trading stocks may generate larger returns, the knowledge, skill and time required to successfully trade stocks may prevent the majority of individual investors from participating in stock trading activities.

### SUMMARY OF THE INVENTION

The present invention relates to a system and method for automated stock value prediction and trading. The solution proposed by the inventors is an automated stock trading system which utilizes a prediction module to predict the movement of a stock price based on an analysis of the movement of the stock price over time, and a decision module to determine when to buy or sell the stock. These modules may be integrated together with a brokerage trading account to allow individual investors to execute stock trade operations automatically.

The inventors propose a novel use of a Least Mean Square (LMS) prediction algorithm to predict stock closing prices in a d+1 period, where d is a given increment of time (as measured in days, for example). More generally, the inventors propose the use of a transversal structure implemented M-order Finite Impulse Response (FIR) filter and an LMS prediction algorithm to adjust the filter coefficients. Based on the calculated predicted value resulting from the M-order FIR filter, the available funds in the investor's account, and the current price of a stock, the decision algorithm may be adapted to choose whether to hold, buy or sell the stock. Use of this automated system may give individual investors an improved chance of obtaining a better return on investment than may be achieved by ad hoc purchasing and selling of the stock.

Thus, in an aspect of the invention, there is provided a method of predicting a value of a stock, comprising: i) inputting M previous time period values for the stock into a M-order finite impulse response (FIR) filter, the M-order finite impulse filter having a filter order M, a least mean square (LMS) prediction algorithm with step-size mu, and M adjustable filter coefficients; ii) obtaining an output from the M-order FIR filter, the output from the M-order FIR filter being a predicted next time period value for the stock; iii) comparing the predicted next time period value for the stock with an actual next time period value for the stock to calculate a prediction error; iv) inputting the calculated prediction error into an adaptive algorithm to obtain an adjustment for the M adjustable filter coefficients; and v) applying the adjustment for the M adjustable filter coefficients and repeating all steps until halted.

In an embodiment, the method further comprises, prior to step i), obtaining a sample of N previous days values for a stock and utilizing the sample of N previous days values to obtain the filter order M and the LMS step-size.

In another embodiment, the method further comprises: receiving the predicted next time period value for the stock; and in dependence upon the predicted next time period value, executing one of a hold, buy or sell order for the stock.

In another embodiment, the method further comprises: if the predicted next time value is higher than a present value, then executing a buy order for the stock; if the predicted next time value is lower than the present value, then executing a sell order for the stock; and if the predicted next time value is the same as the present value, then executing a hold on the stock.

In another embodiment, the method further comprises: considering a transaction cost of a buy order or a sell order; and executing the buy order or sell order only if a resulting gain or loss in total stock holdings is greater than the transaction cost.

In another embodiment, the method further comprises: executing the buy order or sell order for a portion of the total stock holdings.

In another embodiment, the time period is a day.

In another aspect of the invention there is provided a system for predicting a value of a stock, comprising: means for inputting M previous time period values for the stock into a M-order finite impulse response (FIR) filter, the M-order finite impulse response filter having a filter order M, a least mean square (LMS) prediction algorithm with step-size mu, and M adjustable filter coefficients; means for obtaining an output from the M-order FIR filter, the output from the M-order FIR filter being a predicted next time period value for the stock; means for comparing the predicted next time period value for the stock with an actual next time period value for the stock to calculate a prediction error; means for inputting the calculated prediction error into an adaptive algorithm to obtain an adjustment for the M adjustable filter coefficients; and means for applying the adjustment for the at least one adjustable filter coefficient and repeating all steps until halted.

In an embodiment, the system further comprises means for obtaining a sample of N previous days values for a stock and utilizing the sample of N previous days values to obtain the filter order M and the LMS step-size.

In another embodiment, the system further comprises: means for receiving the predicted next time period value for the stock; and means for executing one of a hold, buy or sell order for the stock in dependence upon the predicted next time period value.

In another embodiment, the system further comprises: means for executing a buy order for the stock if the predicted next time value is higher than a present value; means for executing a sell order for the stock if the predicted next time value is lower than the present value; and means for executing a hold on the stock if the predicted next time value is the same as the present value.

In another embodiment, the system further comprises: means for considering a transaction cost of a buy order or a sell order; and means for executing the buy order or sell order only if a resulting gain or loss in total stock holdings is greater than the transaction cost.

In another embodiment, the system further comprises: means for executing the buy order or sell order for a portion of the total stock holdings.

In another embodiment, the time period is a day.

In another aspect of the invention there is provided a data processor readable medium storing data processor code that when loaded onto and executed by a data processing device adapts the device to perform a method of predicting a value of a stock, the data processor readable medium comprising: code for inputting M previous time period values for the stock into a M-order finite impulse response (FIR) filter, the M-order finite impulse filter having a filter order M, a least mean square (LMS) prediction algorithm with step-size mu, and M adjustable filter coefficients; code for obtaining an output from the M-order FIR filter, the output from the M-order FIR filter being a predicted next time period value for the stock; code for comparing the predicted next time period value for the stock with an actual next time period value for the stock to calculate a prediction error; code for inputting the calculated prediction error into an adaptive algorithm to obtain an adjustment for the at least one adjustable filter coefficient; and code for applying the adjustment for the at least one adjustable filter coefficient and repeating all steps until halted.

In an embodiment, the data processor readable medium further comprises: code for obtaining a sample of N previous days values for a stock and utilizing the sample of N previous days values to obtain the filter order M and the LMS step-size.

In another embodiment, data processor readable medium further comprises: code for receiving the predicted next time period value for the stock; and code for executing one of a hold, buy or sell order for the stock in dependence upon the predicted next time period value.

In another embodiment, the data processor readable medium further comprises: code for executing a buy order for the stock if the predicted next time value is higher than a present value; code for executing a sell order for the stock if the predicted next time value is lower than the present value; and code for executing a hold on the stock if the predicted next time value is the same as the present.

In another embodiment, the data processor readable medium further comprises: code for considering a transaction cost of a buy order or a sell order; and code for executing the buy order or sell order only if a resulting gain or loss in total stock holdings is greater than the transaction cost.

In another embodiment, the data processor readable medium further comprises code for executing the buy order or sell order for a portion of the total stock holdings.

These and other aspects of the invention will become apparent from the following more particular descriptions of exemplary embodiments.

### BRIEF DESCRIPTION OF THE DRAWINGS

The figures illustrate exemplary embodiments of the invention.

FIG. 1 shows a generic data processing system that may provide a suitable operating environment.

FIG. 2 shows a schematic block diagram of a system in accordance with an embodiment.

FIG. 3 shows a more detailed schematic block diagram of the prediction module of FIG. 2.

FIG. 4A shows an illustrative example of a LMS prediction graph for a stock.

FIG. 4B shows an illustrative example of the evolution of LMS coefficients over time.

FIG. 4C shows another illustrative example of a LMS prediction graph for another stock.

FIG. 4D shows another illustrative example of a LMS prediction graph for another stock.

FIG. 5 shows a schematic flowchart of an illustrative method in accordance with an embodiment.

### DETAILED DESCRIPTION OF THE INVENTION

As noted above, the present invention relates to a system and method for automated stock value prediction and trading.

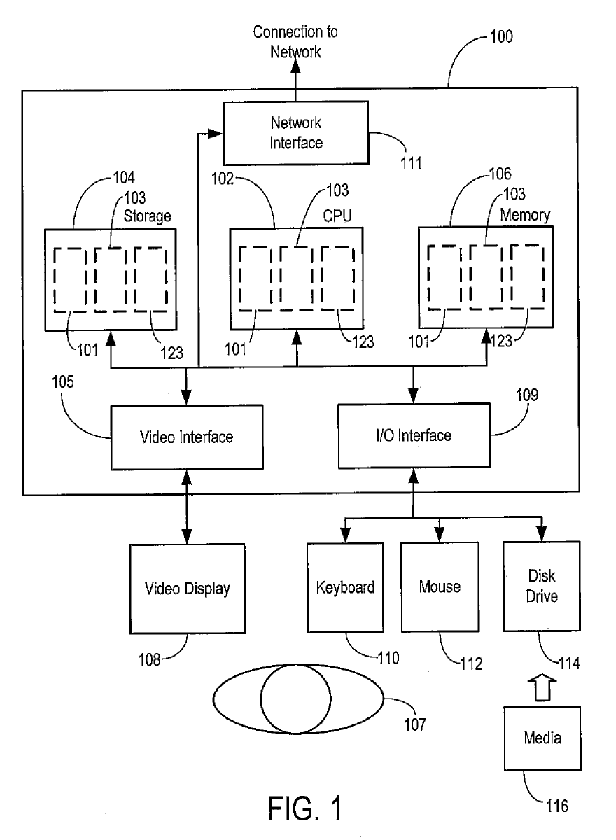

The invention may be practiced in various embodiments. A suitably configured data processing system, and associated communications networks, devices, software and firmware may provide a platform for enabling one or more of these systems and methods. By way of example, FIG. 1 shows a generic data processing system 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. An operator 107 may interact with the data processing system 100 using a video display 108 connected by a video interface 105, and various input/output devices such as a keyboard 110, mouse 112, and disk drive 114 connected by an I/O interface 109. In known manner, the mouse 112 may be configured to control movement of a cursor in the video display 108, and to operate various graphical user interface (GUI) controls appearing in the video display 108 with a mouse button. The disk drive 114 may be configured to accept data processing system readable media 116. The data processing system 100 may form part of a network via a network interface 111, allowing the data processing system 100 to communicate with other suitably configured data processing systems (not shown). The particular configurations shown by way of example in this specification are not meant to be limiting.

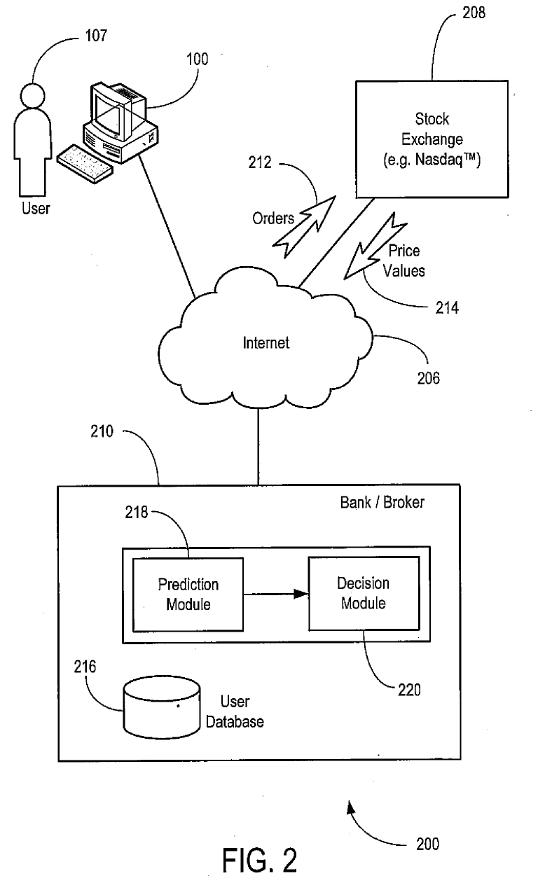

Now referring to FIG. 2, shown is a schematic block diagram of a system 200 in accordance with an embodiment. As shown, the operator 107 of data processor 100 may be an investor wishing to participate in trading stock listed on a stock exchange 208 using the services of a bank or stock broker server 210. The data processor 100, stock exchange 208 and stock broker server 210 may be connected via the Internet 206, for example, or some other suitable public or private network.

Still referring to FIG. 2, the stock broker server 210 may include a user database 216 which includes a user account for investor 107. This user database 216 may store information including the stocks currently held by investor 107, and may update the value of the stock holdings of investor 107 by regularly receiving price values 214 from the stock exchange 208. The stock broker server 210 may also be adapted to send purchase or sell orders 212 to the stock exchange 208 on behalf of the investor 107.

In an embodiment, the stock broker server 210 may include a prediction module 218 which may be adapted to predict future values of the stock held by investor 107, and to provide the predicted value to a decision module 220. The prediction module 218 will be described in more detail below. Based on the predicted movement of the stock value from the prediction module 218, the decision module 220 may be adapted to hold the stock, or to buy or sell the stock on behalf of investor 107 by issuing a buy or sell order 212 sent to the stock exchange 208 via the Internet 206.

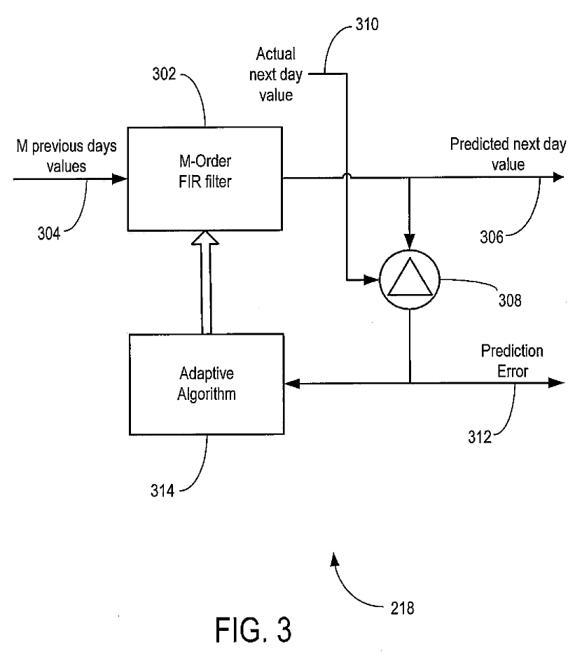

Now referring to FIG. 3, shown is a more detailed schematic block diagram of the prediction module 218 of FIG. 2. More generally, prediction module 318 may be adapted to predict the stock price value at n+1, given M previous values (n−M, n−M+1, . . . , n), by applying digital signal processing (DSP) techniques. As shown, the prediction module 218 may include a M-order FIR (Finite Impulse Response) filter 302 implemented as a transversal structure, and which receive an input comprising the closing values 304 of a stock for the past M previous time periods. A particular implementation of a transversal structure is taught, for example, by A. Oppenheim, R. Schafer and J. Buck in Discrete-Time Signal Processing, 2^{nd} Edition, Prentice Hall, at p. 367 and following.

The M-Order FIR filter 302 may process the input closing values 304 into an output comprising the predicted next time period value 306. For the purposes of this discussion, the time period in question will be assumed to be days. However, it will be appreciated that the time period may also be weeks, hours, minutes, or any standard length of time selected by a user.

The predicted next day value 306 may be compared against the actual next day value 310 as retrieved from the stock exchange at comparison node 308, and the difference may by output as a prediction error 312. The prediction error 312 may then be provided as a feedback input into adaptive algorithm 314, in order to adjust the M filter coefficients in the M-Order FIR filter 302 for the next iteration of stock value prediction using M previous days values.

In selecting a suitable algorithm for the prediction module 218, the inventors found that a LMS (Least Mean Square) algorithm is a good choice for modeling stock prices, as it considers only the current prediction error 312 value when minimizing mean square error. It is important to realize, however, that the LMS algorithm requires a high-order FIR filter. Testing by the inventors has shown that the filter order M and LMS step-size (mu) must also be adjusted for each different stock, as the stock graphs feature different statistical behavior and therefore, different variances which affects the adaptive algorithm. However, once the filter order M and the step-size mu are defined, the inventors found that these values need not be changed frequently, as the statistical properties of a specific stock graph rarely change abruptly. While the filter order M and LMS step-size mu remains relatively constant once determined, the M filter coefficients for the M-Order FIR filter may change frequently, depending on the level of prediction error 312. This will be explained in more detail further below.

In order to validate the stock value prediction model proposed for prediction module 218, the inventors selected a number of stocks for testing purposes. Before the prediction module 218 is first used to predict a future value for a given stock, a sufficiently large sample history of N previous stock closing values were used in order to calibrate the filter order M and LMS step-size (mu) for the given stock. As an illustrative example, for testing purposes, a 400-day sample array of previous closing values were obtained for each stock. The first 300 samples in this array were used as a training sequence to calibrate the filter order M and LMS step-size (mu). After calibration using this training sequence, the remaining 100 samples in the array were used as a test sample to predict the next day values using M previous days values, where M is also the filter order.

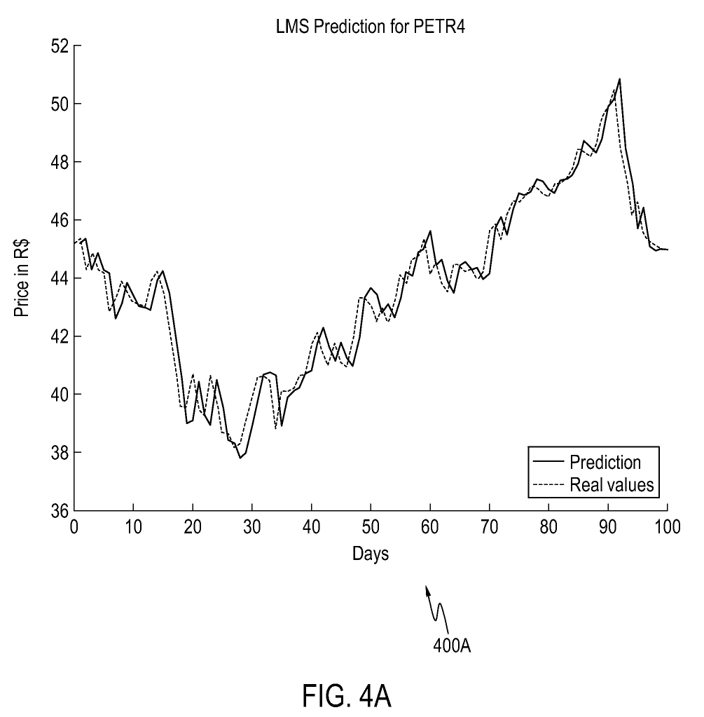

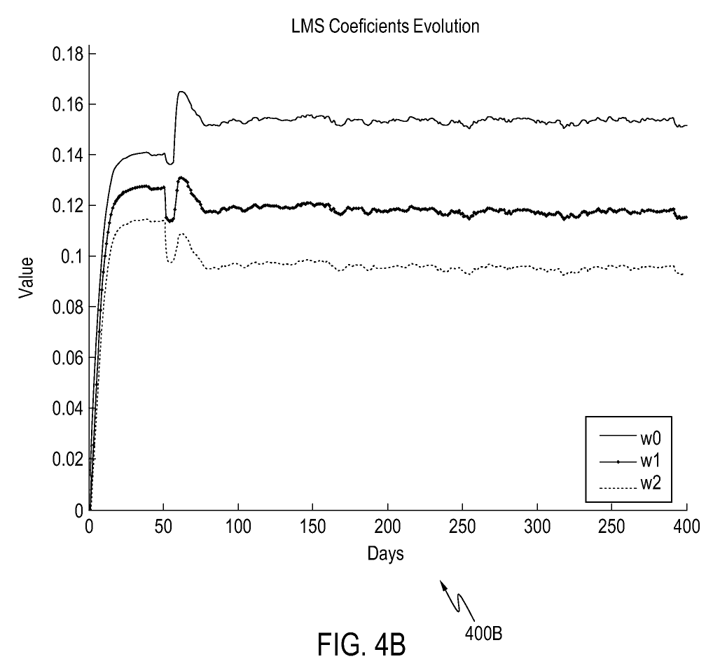

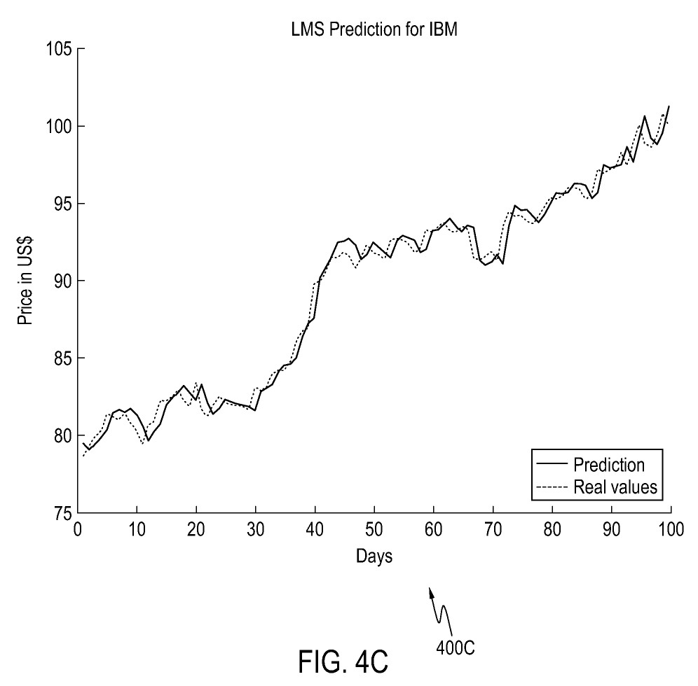

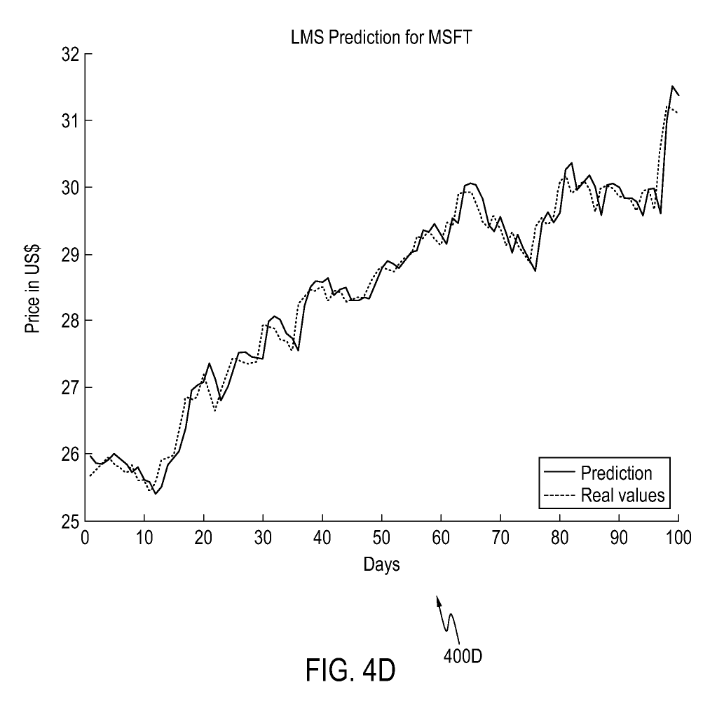

For testing purposes, the inventors first selected the stock prices for Petrobras PN (PETR4) from São Paulo Stock Exchange (BOVESPA) over a 400-day period. Upon running the training sequence using 300 samples, the values for the M-Order FIR filter were set at M=32 and mu=0.0000178. With these values set, the next day stock value prediction was simulated over 100 days, and graphed against the actual real values as shown in graph 400A of FIG. 4A.

The inventors found that the calibrated prediction module 218 was able to predict the n+1 values for the stock with a small margin of error in most cases, and further found that filter coefficient values for the LMS algorithm quickly converge to a virtual steady state, as shown in FIG. 4B with a few illustrative coefficients w0, w1 and w2.

Referring back to FIG. 4A, from the sample stock data obtained from BOVESPA, the initial price in this illustrative 100-day sample period is 45.29 per share. As PETR4 stock is available for purchase only in 100-share batches, the minimum purchase value is R$ 4529.00 in shares. Assuming that investor 107 has R$ 20,000.00 in his account, and purchases 400 shares valued at R$ 18,116.00, if the investor 107 buys the 400 shares and does nothing, then after 100 days the investor will have R$ 17,956.00. The final result (considering the remaining money in investor 107's account) would be R$ 19,840.00, or a loss of 0.8%. In comparison, if the investor had used the prediction module 218 to automatically hold or buy the stock (if possible) while the prediction module 218 predicted that the prices will go up, and otherwise triggered an automatic sale, the investor would have had R$ 22,431.00 after 100 days, or a profit of 12.16%.

In an embodiment, the decision to hold, buy or sell stock may be made at the end of each period (in this case, each day, since it's a daily-based graph). Also, in the preferred embodiment the decision algorithm may be configured to buy or sell 100% of the stock holdings if the prediction is for a higher or lower price, respectively. However, it will be appreciated that the decision algorithm may be configured to buy or sell less than 100% of the holdings if there are any applicable restrictions or trading rules governing the buying or selling of the holdings.

As will be appreciated, if there are transaction costs associated with a buy or sell transaction, as charged by the broker for example, frequent buying and selling may impact upon the level of profit. The simulations in the present illustrative example do not consider the transaction costs of buying and selling, but these transaction costs may be added to the model as may be necessary. It will be appreciated, however, that the transaction costs may vary from country to country, and even from broker to broker.

In an embodiment, in order to address the transactional costs, the buy or sell decision may be made after comparing the transactional cost to the expected gain or loss from buying or selling the holdings. Thus, if an expected gain is greater than the transaction cost associated with buying (additional) holdings, then a buying order may be triggered. And if an expected loss is greater than the transaction cost, then a sell order may be triggered.

Using the same method as described for the PETR4 stock in FIG. 4A, the inventors selected another stock for IBM over a 100-day period, as shown in FIG. 4C. In this case, the calculated values for the filter order and step-size were M=32 and mu=0.000004. Transactional costs for buying or selling were not considered, and it was assumed that 100% of the holdings wound be bought or sold based on the prediction model. Assuming a US$ 20,000.00 account in investor 107's account on day 1, and a minimum buy of 100-share batches on day 1 at $7867*2=USD$15,734, after 100 days, an ad hoc purchase would have resulted in US$ 20,004.00, or a 0.04% profit. In comparison, using the automated prediction module 218, the result would have been US$ 22,546.00, or a 12.73% profit.

Now referring to FIG. 4E, as another illustrative example, the inventors selected stock for Microsoft over a 100-day period. For this stock, the calculated values for the filter order and step-size were M=32, and mu=0.000045. Assuming US$ 20,000.00 in investor 107's account, after 100 days, a one-shot purchase and hold strategy would have resulted in US$ 21,770.00, or 8.85% profit. In comparison, using the prediction module 218 and the same assumptions as used for buying and selling as used for FIG. 4D, the investor 107 would have had US$ 22,548.00 after the 100-day period, or a 12.74% profit.

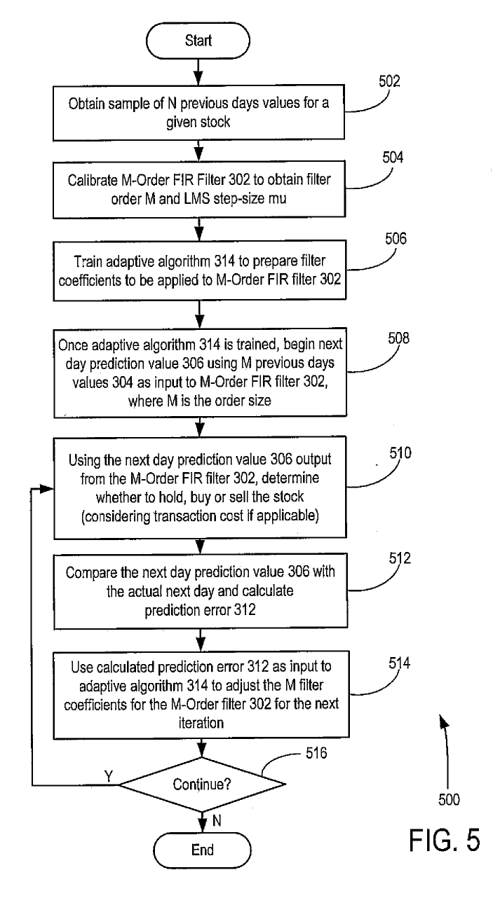

Now referring to FIG. 5, and referring back to FIG. 3, shown is a schematic flowchart of a method 500 in accordance with an embodiment. As shown, method 500 begins and at block 502 where, as a preliminary step, method 500 obtains a sufficiently large sample of N previous days values for a given stock that an investor wishes to invest in.

Next at block 504, method 500 uses the sample of N previous days values in order to calibrate the M-Order FIR filter 302, and to obtain values for the filter order M and the LMS step-size (mu) for the given stock. Once the M and mu values have been determined, an input array of M elements may be provided for the M-Order FIR filter 302 for all subsequent iterations. This array contains the M previous days closing prices (including today).

Next, at block 506, the sample of N previous days values is also used to train the adaptive algorithm 314, and to prepare the filter coefficients to be applied to M-Order FIR filter 302.

Next, at block 508, once the adaptive algorithm 314 has been trained, prediction of the future stock value may begin using M previous days values 304 as an input to M-Order FIR filter 302, where M is the order size of the M-Order FIR filter 302, and the output of the M-Order FIR filter 302 is the predicted next day value 306.

Method 500 may then proceed to block 510, where the predicted next day value 306 output from the M-Order FIR filter 302 (i.e., from prediction module 218 of FIG. 2) may be used by a decision module 220 (FIG. 2) to determine whether to hold, buy, or sell the stock, depending on whether the next day prediction value is steady, increasing, or decreasing. As an illustrative example, in an embodiment, if the predicted next day value 306 is steady, then the decision module 220 may determine that the stock should be held. If the predicted next day value 306 is higher, then the decision module 220 may trigger a buy order 212 to purchase more stock if possible, given the investor's available funds. If the predicted next day value 206 is decreasing, then the decision module 220 may trigger a sell order 212 to sell stock.

In an embodiment, the decision module 220 may be configured to consider any applicable transaction costs before a buy or sell order is triggered by decision module 220. For example, if the expected gain or loss is greater than the transaction cost, then the buy or sell order may be triggered.

Method 500 may then proceed to block 512 where, after closing of the stock exchange 208 the next day, the predicted next day value 306 may be compared with the actual next day value 310 (e.g., as received from the stock exchange) in order to calculate a prediction error 312.

Next, method 500 may proceed to block 514, where the calculated prediction error 312 is used as an input to adaptive algorithm 314 in order to adjust the M filter coefficients for the M-Order FIR filter 302 for the next iteration.

Method 500 may then proceed to decision block 516, where method 500 may either return to block 510 to continue, or end.

While various illustrative embodiments of the invention have been described above, it will be appreciated by those skilled in the art that variations and modifications may be made. Thus, the scope of the invention is defined by the following claims.

What is claimed is:

1. A method of predicting the value of a stock, comprising:
i) inputting M previous time period values for the stock into a M-order finite impulse response (FIR) filter, the M-order finite impulse filter having a filter order M, a least mean square (LMS) prediction algorithm with step-size mu, and M adjustable filter coefficients;
ii) obtaining an output from the M-order FIR filter, the output from the M-order FIR filter being a predicted next time period value for the stock;
iii) comparing the predicted next time period value for the stock with an actual next time period value for the stock to calculate a prediction error;
iv) inputting the calculated prediction error into an adaptive algorithm to obtain an adjustment for the M adjustable filter coefficients; and
v) applying the adjustment for the M adjustable filter coefficients and repeating all steps until halted.

2. The method of claim 1, further comprising, prior to step i), obtaining a sample of N previous days values for a stock and utilizing the sample of N previous days values to obtain the filter order M and the LMS step-size.

3. The method of claim 1, further comprising:
receiving the predicted next time period value for the stock; and
in dependence upon the predicted next time period value, executing one of a hold, buy or sell order for the stock.

4. The method of claim 3, further comprising:
if the predicted next time value is higher than a present value, then executing a buy order for the stock;
if the predicted next time value is lower than the present value, then executing a sell order for the stock; and
if the predicted next time value is the same as the present value, then executing a hold on the stock.

5. The method of claim 4, further comprising:
considering a transaction cost of a buy order or a sell order; and
executing the buy order or sell order only if a resulting gain or loss in total stock holdings is greater than the transaction cost.

6. The method of claim 4, further comprising:
executing the buy order or sell order for a portion of a total stock holdings.

7. The method of claim 1, wherein the time period is a day.

8. A system for predicting the value of a stock, comprising:
means for inputting M previous time period values for the stock into a M-order finite impulse response (FIR) filter, the M-order finite impulse response filter having a filter order M, a least mean square (LMS) prediction algorithm with step-size mu, and M adjustable filter coefficients;
means for obtaining an output from the M-order FIR filter, the output from the M-order FIR filter being a predicted next time period value for the stock;
means for comparing the predicted next time period value for the stock with an actual next time period value for the stock to calculate a prediction error;
means for inputting the calculated prediction error into an adaptive algorithm to obtain an adjustment for the M adjustable filter coefficients; and
means for applying the adjustment for the at least one adjustable filter coefficient and repeating all steps until halted.

9. The system of claim 8, further comprising, means for obtaining a sample of N previous days values for a stock and utilizing the sample of N previous days values to obtain the filter order M and the LMS step-size.

10. The system of claim 8, further comprising:
means for receiving the predicted next time period value for the stock; and
means for executing one of a hold, buy or sell order for the stock in dependence upon the predicted next time period value.

11. The system of claim 10, further comprising:
means for executing a buy order for the stock if the predicted next time value is higher than a present value;
means for executing a sell order for the stock if the predicted next time value is lower than the present value; and
means for executing a hold on the stock if the predicted next time value is the same as the present value.

12. The system of claim 11, further comprising:
means for considering a transaction cost of a buy order or a sell order; and
means for executing the buy order or sell order only if the resulting gain or loss in total stock holdings is greater than the transaction cost.

13. The system of claim 11, further comprising means for executing the buy order or sell order for a portion of a total stock holdings.

14. The system of claim 8, wherein the time period is a day.

15. A data processor readable medium storing data processor code that when loaded onto and executed by a data processing device adapts the device to perform a method of predicting the value of a stock, the data processor readable medium comprising:
code for inputting M previous time period values for the stock into a M-order finite impulse response (FIR) filter, the M-order finite impulse filter having a filter order M, a least mean square (LMS) prediction algorithm with step-size mu, and M adjustable filter coefficients;
code for obtaining an output from the M-order FIR filter, the output from the M-order FIR filter being a predicted next time period value for the stock;
code for comparing the predicted next time period value for the stock with an actual next time period value for the stock to calculate a prediction error;
code for inputting the calculated prediction error into an adaptive algorithm to obtain an adjustment for the at least one adjustable filter coefficient; and
code for applying the adjustment for the at least one adjustable filter coefficient and repeating all steps until halted.

16. The data processor readable medium of claim 15, further comprising, code for obtaining a sample of N previous days values for a stock and utilizing the sample of N previous days values to obtain the filter order M and the LMS step-size.

17. The data processor readable medium of claim 15, further comprising:
code for receiving the predicted next time period value for the stock; and
code for executing one of a hold, buy or sell order for the stock in dependence upon the predicted next time period value.

18. The data processor readable medium of claim 17, further comprising:
code for executing a buy order for the stock if the predicted next time value is higher than a present value;
code for executing a sell order for the stock if the predicted next time value is lower than the present value; and
code for executing a hold on the stock if the predicted next time value is the same as the present.

19. The data processor readable medium of claim 18, further comprising:
code for considering a transaction cost of a buy order or a sell order; and
code for executing the buy order or sell order only if the resulting gain or loss in total stock holdings is greater than the transaction cost.

20. The data processor readable medium of claim 18, further comprising code for executing the buy order or sell order for a portion of a total stock holdings.
